(19) United States
(12) Patent Application Publication
(10) Pub. No.: US 2010/0169316 A1
(43) Pub. Date: Jul. 1, 2010

(54) SEARCH QUERY CONCEPT BASED RECOMMENDATIONS

(75) Inventors: Gaurav GEHLOT, Bangalore (IN); Manish Satyapal GUPTA, Mumbai (IN); Anand Vishwanath SUVARNKAR, Bangalore (IN); Bhupesh GOEL, Faridabad (IN); Looja TULADHAR, Sunnyvale, CA (US)

Correspondence Address: Evergreen Valley Law Group, P.C. and Yahoo! Inc., 4 South Second Street, Suite 598, San Jose, CA, 95113, US

(73) Assignee: Yahoo! Inc., Sunnyvale, CA (US)

(21) Appl. No.: 12/346,832

(22) Filed: Dec. 30, 2008

(51) Int. Cl. G06F 17/30

(52) U.S. Cl. 707/736; 707/E17.014; 707/E17.017; 707/758

(57) ABSTRACT

Search Query Concept Based Recommendations. A method includes electronically receiving, in a computer system, a title as an input. One or more subsets of the title are generated. A list of key phrases associated with the title is obtained. Further, one or more key phrases from the list corresponding to the one or more subsets is electronically identified. Contents are selected based on the one or more key phrases identified. The contents can be ranked. The contents are then provided to the user.

### BACKGROUND

Recommendation systems on a commercial online portal are integral to providing recommendations on products, items, documents, literary resources, and multimedia resources to a user. The recommendation systems rely on online user activity, user profile, and click history of the products in order to correlate products corresponding to a product searched by the user. However, new products introduced in the online portal may not have associated recommendations due to absence of the click history and limited shelf life corresponding to the new products. Further, the limited shelf life may reduce user clicks corresponding to the new products. The recommendations to the products may not be based on content or context, allowing perpetrators to perform fraudulent clicks on recommended products.

Currently existing approach uses user-based collaborative or item-based collaborative filtering algorithms and content-based algorithms for recommendations. In user-based collaborative filtering algorithm, user-to-user similarity is found using the ratings given by users to items whereas item-based algorithm, item to item similarity is found using the common set of users who have viewed both the items. However, collaborative filtering algorithms suffer with the problem of cold-start due to very low number of views for new items or by new users. Content based algorithms try to minimize the problem of cold-start by generating recommendations based on item-to-item similarity regardless of user input. However, using the item-to-item similarity measures, such as cosine similarity of correlation, the number of recommendations generated is not significant. Further, the number of recommendations is further reduced after considering the location filtering used by most of the online portals for geographic targeting of users. Moreover, determining the item-to-item similarity, pair wise, requires significant computation and hence, puts pressure on available resources which can otherwise be utilized for performing other important computations.

In light of the foregoing discussion, there is a need for an efficient technique for content based recommendations.

### SUMMARY

Embodiments of the present disclosure described herein provide a method, system and article of manufacture for content based recommendations.

An example of an article of manufacture includes a machine-readable medium, and instructions carried by the medium and operable to cause a programmable processor to perform receiving a title as an input. One or more subsets of the title are generated. A list of key phrases associated with the title is obtained. Further, one or more key phrases from the list corresponding to the one or more subsets is electronically identified. Contents are selected based on the one or more key phrases identified. The contents are then provided to a user.

An example of an article of manufacture includes a machine-readable medium, and instructions carried by the medium and operable to cause a programmable processor to perform receiving a title as an input. One or more subsets of the title are generated. A list of key phrases associated with the title is obtained. Further, one or more key phrases from the list corresponding to the one or more subsets is electronically identified. The title is associated with the one or more key phrases. The title and the one or more key phrases are then stored.

An example of an article of manufacture for content based recommendations includes a machine-readable medium, and instructions carried by the medium and operable to cause a programmable processor to perform identifying one or more products associated with a product relevant to a user based on affinity based recommendation. The one or more products are displayed if the number of the one or more products meets a predefined threshold. A list of key phrases associated with the product is then obtained if the number of the one or more products does not meet a predefined threshold. One or more key phrases are then electronically identified from the list corresponding to the product. The products are then selected based on the one or more key phrases. The products are displayed to the user.

An example of a method includes receiving a title as an input. One or more subsets of the title are generated. A list of key phrases associated with the title is obtained. Further, one or more key phrases from the list corresponding to the one or more subsets is electronically identified. Contents are selected based on the one or more key phrases identified. The contents are then provided to a user.

An example for system for content based recommendations includes one or more remotely located electronic devices. The system also includes a communication interface in electronic communication with the one or more remotely located electronic devices for receiving a title. Further, the system includes a memory for storing instructions. Moreover, the system includes a processor responsive to the instructions to generate one or more subsets of the title, to identify one or more key phrases from a list of key phrases, and to provide contents based on the one or more key phrases. The system also includes one or more storage devices in electronic communication with the communication interface for storing the list of key phrases, the title and the one or more key phrases.

### BRIEF DESCRIPTION OF THE FIGURES

FIG. 1 is a block diagram of an environment, in accordance with which various embodiments can be implemented;

FIG. 2 is a block diagram of a server, in accordance with one embodiment;

FIG. 3 is a flowchart illustrating a method for content based recommendations to a user, in accordance with one embodiment; and

FIG. 4 is a flowchart for illustrating a method for recommending products, in accordance with one embodiment.

### DETAILED DESCRIPTION OF THE EMBODIMENTS

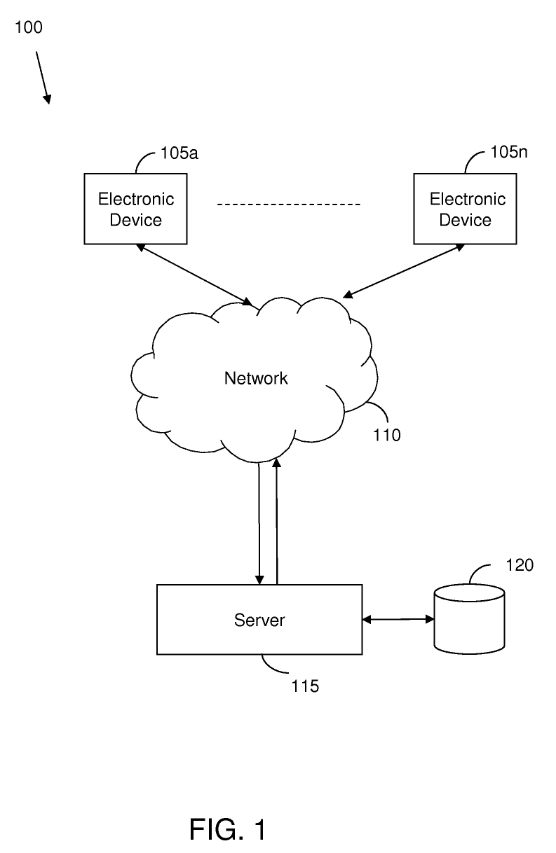

FIG. 1 is a block diagram of an environment 100, in accordance with which various embodiments can be implemented. The environment 100 includes one or more electronic devices, for example an electronic device 105a and an electronic device 105n, connected to each other through a network 110. Examples of the electronic devices include, but are not limited to, computers, laptops, mobile devices, hand held devices, and personal digital assistants (PDAs). Examples of the network 110 include but are not limited to a Local Area Network (LAN), a Wireless Local Area Network (WLAN), a Wide Area Network (WAN), internet and a Small Area Network (SAN). The electronic devices are also connected to a server 115 through the network 110. The server 115 is connected to a storage device 120.

The storage device 120 stores the list of key phrases, the title and the one or more key phrases. The storage device 120 can be a distributed system.

A user of the electronic device 105a accesses a search application, for example Yahoo!® Hot Jobs, and enters a search query. The search query for a particular content, for example a job, is communicated to the server 115 through the network 110 by the electronic device 105a in response to the user inputting the search query. The server 115 communicates contents to the user based on the search query. The server 115 also communicates recommendations associated with the contents communicated to the user. The server 115 can communicate the recommendations based on correlations between the contents communicated, query name, user profile, user click history, user content views, and concept based recommender. The server utilizes the contents stored in the storage device 120 to communicate the contents and to provide the recommendations to the user.

In some embodiments, the user can also search for products on a search application. The search query for a particular product is communicated to the server 115 through the network 110 by the electronic device 105a in response to the user inputting the search query. The server 115 communicates the products to the user based on the search query. The server 115 can also recommend one or more products corresponding to the products communicated based on affinity based recommender and concept based recommender.

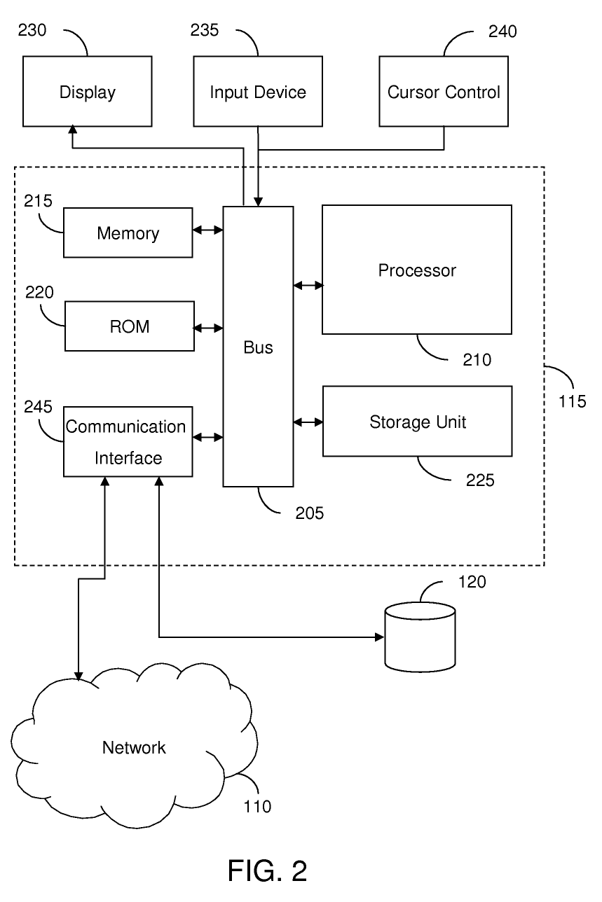

The server 115 includes a plurality of elements for providing the contents. The server 115 including the elements is explained in detail in FIG. 2.

FIG. 2 is a block diagram of the server 115, in accordance with one embodiment. The server 115 includes a bus 205 or other communication mechanism for communicating information, and a processor 210 coupled with the bus 205 for processing information. The server 115 also includes a memory 215, such as a random access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The server 115 further includes a read only memory (ROM) 220 or other static storage device coupled to bus 205 for storing static information and instructions for processor 210. A storage unit 225, such as a magnetic disk or optical disk, is provided and coupled to the bus 205 for storing information.

The server 115 can be coupled via the bus 205 to a display 230, such as a cathode ray tube (CRT), and liquid crystal display (LCD) for displaying information to a user. An input device 235, including alphanumeric and other keys, is coupled to bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230. The input device 235 can also be included in the display 230, for example a touch screen.

Various embodiments are related to the use of server 115 for implementing the techniques described herein. In one embodiment, the techniques are performed by the server 115 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the server 115, various machine-readable medium are involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that comprise the bus 205. Transmission media can also take the form of acoustic or light waves, such as those generated during radio-wave and infra-red data communications. Examples of machine-readable medium may include but are not limited to a carrier wave as describer hereinafter or any other medium from which the server 115 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 115 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on storage unit 225 either before or after execution by the processor 210. All such media must be tangible to enable the instructions carried by the media to be detected by a physical mechanism that reads the instructions into a machine.

The server 115 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

In some embodiments, the server 115 receives a title as an input. The server 115 then generates one or more subsets of the title. The server 115 can then filter the title in order to generate the subsets of the title. The server 115 obtains a list of key phrases associated with the title. The server 115 fetches the key phrases from query logs corresponding to one or more users. The server 115 can also generate a list of blacklisted words. The server 115 can remove the blacklisted words from the key phrases obtained. The server 115 creates one or more pairs of the key phrases. The server 115 then associates each pair of the one or more pairs with a relativity score. The relativity score can be based on statistical similarity between the key phrases in each pair.

In one embodiment, the relativity score can be determined using Jaccard similarity index. The Jaccard similarity index is a statistic used for comparing similarity and diversity of the key phrases. The Jaccard similarity index measures similarity between the key phrases. The Jaccard similarity index can be defined as a ratio of number of times the two key phrases occur together to sum of number of times each key phrase of the two key phrases occurs in the query log.

In another embodiment, the directed associative similarity coefficient can be user for determining relativity score between two key phrases. The directed associative similarity coefficient can be defined as a ratio of number of times the two key phrases occur together in the key phrases obtained to number of times one of the two key phrases occurs in the query log.

The server 115 identifies one or more key phrases from the list of key phrases corresponding to the one or more subsets. The list includes pairs of key phrases. Presence of each subset can be checked in the pairs. If a key phrase in a pair matched the subset then the other key phrase in the pair is identified as a relevant key phrase and can be termed as “key phrase identified” or “identified key phrase”. The server 115 can prioritize the identified key phrases. The server 115 then selects contents based on the key phrases identified. The server 115 can also filter the contents based on the preferences of the user. The server 115 then provides contents to the user. The server 115 can display the contents to the user.

In some embodiments, the server 115 can recommend products. The server 115 first identifies one or more products associated with a product relevant to a user based on affinity based recommendation. The server 115 then displays the one or more products if the number of the one or more products meets a predefined threshold. The server 115 obtains a list of key phrases associated with the product if the number of the one or more products does not meet a predefined threshold. Further, the server 115 identifies one or more key phrases from the list corresponding to the product. The server 115 then selects products based on the one or more key phrases and displays the products to the user.

In some embodiments, the processor 210 can include one or more processing units for performing one or more functions of the processor 210. The processing units are hardware circuitry performing specified functions.

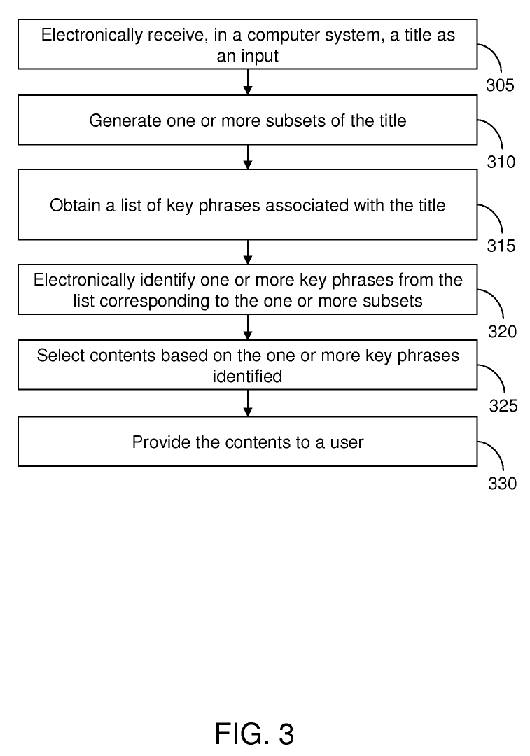

FIG. 3 is a flowchart illustrating a method for content based recommendations to a user, in accordance with one embodiment.

A user of an electronic device can use an online application, for example a job portal, running on the electronic device for searching jobs. The online application can include any application on which searching can be performed, for example product search, and job search.

At step 305, a title is received an input. A title can be defined as content or combination of words related to a job or a product. When the user performs a search, for example a job search, then several results can be displayed. The results can include job titles and product titles. An icon, for example “similar results” icon can be displayed against each result. The title can be received in response to the user clicking on the icon displayed on the screen.

At step 310, one or more subsets of the title are generated. The title can also be referred to as “received title”.

In some embodiments, generating includes filtering the title. The title can be filtered by removing the words in the title which are present in a list of blacklisted words. The list of blacklisted words can be fetched from the storage device. The list of blacklisted words can be generated and stored in the storage device. The list of blacklisted can be generated based on user queries and titles displayed to the user in response to the user queries. The data including the user queries and the titles displayed can be collected for a period of around one month. A set of words present in the titles and absent in the user queries for multiples times are identified as blacklisted words. The blacklisted words can also include a static list of stop words used typically.

For example, consider the user queries including key phrases “sales”, “retail”, “marketing” and “oracle” and the titles including “Retail Sales—Troy N.Y.”, “Retail Background a Plus In Sales and Marketing Firm Trains” and “Entry Level Oracle Sales Marketing”. The blacklisted words can be generated by segregating the key phrases from the titles. The blacklisted words can then include “Troy”, “NY”, “Background”, “a”, “plus”, “In”, “and”, “firm”, “trains”, “Entry”, and “Level”.

In some embodiments, the generating also includes stemming the received title. Examples of a stemmer for stemming the title include, but are not limited to, a libyell stemmer and a teragram stemmer.

The subsets of the received title are then generated. The subsets include entire title as it is after removal of the blacklisted words and stemming, and a subset generated by taking one or more words from the title remaining after removal of the blacklisted words and stemming. The one or more words can be taken in various possible combinations. For example, if the received title is “Software Engineer in Test, Troy N.Y.” then after stemming and removal of blacklisted words the title can be “Software Engineer Test”. The subsets can then include:
Software Engineer Test
Software Engineer
Engineer Test
Software Test
Software
Engineer
Test

Each subset can be assigned a weightage. For example, “Software Engineer Test” can be assigned a weightage of 100, “Software Engineer”, “Engineer Test” and “Software Test” can be assigned a weightage of 66 individually, and Software, Engineer and Test can be assigned a weightage of 1 individually. The weightage is dependent on size of each subset of the title. The size of a subset can correspond to number of key phrases in the subset. Maximum weightage can be allotted to the title obtained after removal of the blacklisted words and stemming, and the weightage of other subsets can be relative to the maximum weightage. The weightage of other subsets can be calculated by a formula:

Weightage=((100)̂(1/size of the title))̂(size of the subset)

As illustrated in the formula, 100 can be the maximum weightage allotted to the title obtained after removal of the blacklisted words and stemming. The weightage associated with the subsets can vary from 1 to 100 as per the formula.

At step 315, a list of key phrases associated with the title is obtained. The list of key phrases includes pairs of key phrases.

In one embodiment, the list of key phrases can be generated based on user session log based key phrase similarity. The key phrases can be obtained from query logs associated with a user. The query log can be defined as a 3-tuple data for a session. Examples of the query logs can include, but are not limited to, key phrases associated with queries made by the user, timestamps associated with the queries and user identifications associated with the user; and browser cookies, timestamps and key phrases. The query logs can be obtained for a user session. For example, a query log can include key phrases entered under the same user-id and whose time stamps are not separated by a constant “MAX_TIME_BETWEEN_QUERIES_WITHIN_A_SESSION”, for example 30 minutes.

The list of key phrases can be generated and stored in the storage device.

Table 1 illustrates an exemplary query log. The query log includes the key phrases entered by the user, timestamp, and browser cookies.

TABLE 1

| BROWSER | | |
|---|---|---|
| COOKIES | TIMESTAMPS | KEY PHRASES |
| 000085t4ar1fm | 1219331785 | engineer software |
| 000085t4ar1fm | 1219331785 | developer software |
| 000085t4ar1fm | 1219331789 | application engineer |
| 000085t4ar1fm | 1219331789 | programmer |
| 000085t4ar1fm | 1219331806 | engineer network |
| 000085t4ar1fm | 1219331838 | computer programmer |
| 000085t4ar1fm | 1219331870 | developer web |
| 000091d4ate4q | 1220731322 | engineer software test |
| 000091d4ate4q | 1220731331 | assurance quality |
| 000091d4ate4q | 1220731341 | assurance engineer quality software |
| 000091d4ate4q | 1220731355 | development engineer test |
| 000091d4ate4q | 1220731371 | analyst software |
| 000091d4ate4q | 1220731375 | engineer system |
| 0000e513i7kke | 1219574360 | engineer test |
| 0000e513i7kke | 1219574376 | engineer rf |
| 0000e513i7kke | 1219574437 | engineer quality test |
| 0000e513i7kke | 1219574480 | analyst test |

Pairs of the key phrases can be created using all the key phrases present in the query log. In some embodiments, the pairs of the key phrases can be created using consecutive key phrases present in the query log.

The pairs of the key phrases across multiple user sessions can then be assimilated and a count of occurrence of each pair in the multiple user sessions is determined. The pairs of the key phrases with maximum count are identified. A relativity score between the key phrases in a pair is then determined based on statistical similarity between the key phrases. In one embodiment, the relativity score between the key phrases in each pair can be determined using jaccard similarity index. The Jaccard similarity index corresponding to each pair can vary from 0 to 1. The Jaccard similarity index can be defined as a ratio of number of times the two key phrases occur together to sum of number of times each key phrase of the two key phrases occurs in the query log.

In another embodiment, the directed associative similarity coefficient can be user for determining relativity score between two key phrases. The directed associative similarity coefficient can be defined as a ratio of number of times the two key phrases occur together to number of times one of the two key phrases occurs in the query log.

Table 2 illustrates an exemplary list of key phrases with the relativity score obtained from query log in Table 1.

TABLE 2

| Key Phrase 1 | Key Phrase 2 | Relativity Score |
|---|---|---|
| engineer software | developer software | 0.020553763 |
| engineer software | application engineer | 0.01319854 |
| programmer | engineer software | 0.005278831 |
| engineer network | engineer software | 0.002819705 |
| engineer software | computer programer | 0.004945904 |
| developer web | engineer software | 0.003089826 |
| development engineer | assurance quality | 0.001492537 |
| test | | |
| engineer software test | assurance engineer quality | 0.002700878 |
| | software | |
| engineer system test | engineer lead test | 0.005230602 |
| engineer software test | development engineer test | 0.003558719 |
| engineer software test | analyst software | 0.003527337 |
| engineer software test | engineer system | 0.004658385 |
| lead test | engineer test | 0.001736111 |
| engineer test | Engineer rf | 0.00132626 |
| engineer test | engineer quality test | 0.001805054 |
| engineer test | analyst test | 0.001713307 |

Each pair in the list is associated with a relativity score.

In another embodiment, the list of key phrases can be generated based on user click history log based key phrase similarity. A user can submit a query key phrase K1. The user then sees contents as search results. The user then clicks on result R1, R5, and R7. Now results R1, R5, and R7 may also have been clicked by the same or some other user when the same or the other user searched for key phrase K2. If the clicks on the results R1, R5, and R7 happen frequently while searching for K1 and K2 then K1 and K2 are determined as related key phrases and included in the list. A log can be maintained of all such query key phrases, and search results pairs. An entry (R, K) appears in the log if the result “R” was clicked at least “T” number of times when the user searched using any of such key phrase K. The relativity score between two key phrases K1 and K2 can be expressed as number of results that appeared when user queried for K1 and also appeared when user queried for K2. For example, when a jobseeker searches for “java developer” he gets a result set R1 and when he searches for “java engineer” he gets a result set R2. If R1 and R2 have ‘a’ common listings out of the top ‘b’ results, then the similarity between “java developer” and “java engineer” can be a/b. The 2 key phrases K1 and K2 are recognized as similar if K1 and K2 are present together in at least one job description.

In some embodiments, the pair of key phrases that appear in both the list of key phrases generated based on user session log based key phrase similarity and generate based on user click history log based key phrase similarity can be weighed higher as compared to the pair that appears in one list. The relativity score can then be updated to provide higher weight.

At step 320, one or more key phrases from the list corresponding to the subsets of the title are identified. The key phrases from the list can be identified based on the relativity score associated with each pair and weightage associated with each subset. Each subset is searched in the pairs. The subset will match a key phrase from the pair. The other key phrase from the pair is then identified as the key phrase corresponding to the subset of the title.

A final score can be generated for each such other key phrase identified as the key phrase corresponding to the subset of the title based on the relativity score associated with each pair and weightage associated with each subset. The final score can be generated as follows:

Final Score=Weightage*Relativity Score

For example, for the subset “Software Engineer Test” the other key phrases in Table 2 can include “analyst software”, “engineer system”, “development engineer test”, and “assurance engineer quality software”. The final score can then be:
(100*0.003527336860670194) for “analyst software”
(100*0.004658385093167702) for “engineer system”
(100*0.0035587188612099642) for “development engineer test”
(100*0.0027008777852802163) for “assurance engineer quality software”

Similarly, for the subset “Engineer Test” the other key phrases in Table 2 can include “lead test” and “engineer rf”. The final score can then be:
(0.001326259946949602*66) for “engineer rf”
(0.0018050541516240488*66) for “engineer quality test”

It will be appreciated that each subset can be considered or subsets above a size threshold can be considered. For example, the threshold can be 2. In such case the subsets having more than 2 words will be considered.

In some embodiments, the identified key phrases can be prioritized based on the final score. The key phrases with lower final score can be removed from the identified key phrases. For example, the identified key phrases can be:
“engineer system”=0.4658385093167702
“development engineer test”=0.35587188612099642
“analyst software”=0.3527336860670194
“engineer, quality test”=0.1191335740072202208
“engineer, rf”=0.087533156498673732

In some embodiments, the computation of the identified key phrases for a title can be performed offline. The computation can be performed when the title is posted on a website, for example when a company posts a title corresponding to a job vacancy on Yahoo!® Hot Jobs. The identified key phrases can then be associated with the title and stored in the storage device. The identified key phrases can then be retrieved from the storage device in response to a user clicking on the icon displayed on the screen. The title can be displayed to the user in a keyword based search done by the user.

At step 325, contents corresponding to the identified key phrases are selected. The contents can be selected from the stored contents available in the server or from contents provided in real time by multiple users to the server.

In some embodiments, the contents can also be filtered based on the preferences of the user. Examples of the preferences of the user include, but are not limited to, location criteria, content category, and related fields associated with the contents. For example, if the location is set as Bangalore then the contents associated with Bangalore can be selected while other contents can be filtered out.

In some embodiments, the contents are also ranked based on the preferences of the user. The contents can also be ranked based on the final score of the key phrase. For example, content resulting from a key phrase with higher score can be ranked higher.

At step 330, the contents selected are provided to the user. The contents selected can be displayed to the user.

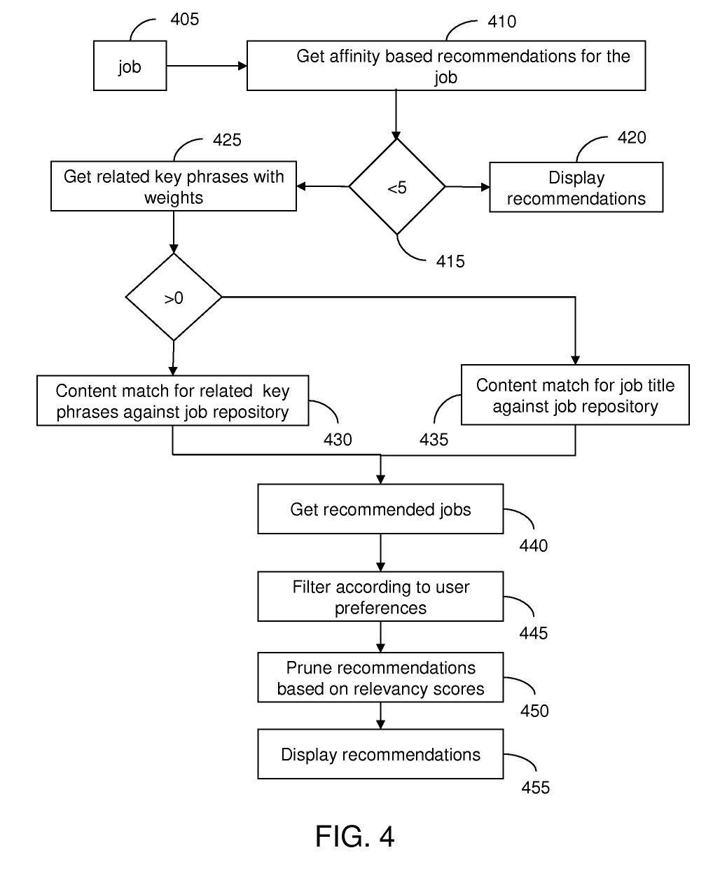

FIG. 4 is a flowchart for illustrating a method for recommending products, for example contents or jobs, in accordance with one embodiment. At step 405 a user makes a job query to search for jobs. At step 410 one or more jobs can be recommended to the user based on affinity based recommendation corresponding to the job query. At step 415 a condition to determine if the recommendations based on the affinity based recommendation meets a predefined threshold is checked. For example, if the predefined threshold for the recommendations is 5 jobs to be recommended, and if more than 5 jobs can be obtained based on affinity based recommendation, then step 420 is performed. At step 420 the 5 jobs can be displayed to the user.

In the affinity based recommendation, contents can be selected directly based on the click history of the user. Affinity between multiple jobs can be determined based on information in the click history related to views and clicks made by multiple users corresponding to the jobs. The information can include, but not limited to, multiple users with views corresponding to each job, the jobs viewed by one of the users, multiple users with clicks corresponding to each job, and the jobs clicked by one of the users. The affinity between the jobs can be determined using jaccard similarity index. The jobs can then be selected for recommendation based on the jaccard similarity index.

If the jobs recommended are less than 5 jobs, then step 425 can be performed. At step 425, a list of key phrases corresponding to job query with relativity score associated with the key phrases are obtained. One or more key phrases from the list corresponding to the job query can then be identified.

At step 430, contents associated with the key phrases obtained can then be matched against a job repository in the server and selected. At step 435 contents associated with the job title associated with the job query can also be matched and selected against a job repository in the server. At step 440, recommended jobs corresponding to the contents match are obtained. At step 445, the recommended jobs obtained can be filtered based on the preferences of the user. At step 450, the contents or recommendations can then be prioritized based on the relativity score by pruning recommendations with low relativity score compared to other recommendations. At step 455, the recommendations prioritized can then be displayed to the user.

In various embodiments, step 405, step 410, step 415, step 420, step 425, step 430, step 435, step 440, step 445, step 450, and step 455 can be performed for recommending products to a user. The title of the product can be received as an input. One or more products associated with a product relevant to a user can be identified based on affinity based recommendation. The products can be displayed to the user if the number of the products meets a predefined threshold. A list of key phrases associated with the product is obtained if the number of the products does not meet the predefined threshold. One or more key phrases from the list corresponding to the product can then be identified. The products can then be selected based on the one or more key phrases. The products are then displayed to the user as recommendations.

The embodiments can be used in various applications, for example, Yahoo!® Hot Jobs, Yahoo!® videos, Yahoo!® movies, and Yahoo!® shopping for searching jobs, videos, movies, and products.

Various embodiments help in broadening the search and performing content based recommendations by considering the identified key phrases. The content similarity is determined at the concept level. The concepts are generated from the search query log available with the online portal to map contents to list of concepts, direct and related. The concepts are then used to generate recommendations.

Other exemplary use cases of the present disclosure includes:

Query rewriting and expansion based on the related key phrases

Determining document similarity based on the Jaccard similarity between pairs of key phrases in two documents.

Concept highlighting including highlighting the “white list key phrases” in long job descriptions. A white list can be defined as a list of key phrases entered by a user frequently as a query.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. An article of manufacture comprising:
a machine-readable medium for content based recommendations; and
instructions carried by the machine-readable medium and operable to cause a programmable processor to perform:
receiving a title;
generating one or more subsets of the title;
obtaining a list of key phrases;
identifying one or more key phrases from the list corresponding to the one or more subsets;
selecting contents based on the one or more key phrases identified; and
providing the contents to a user.

2. The article of manufacture of claim 1, wherein the generating comprises:
filtering the title.

3. The article of manufacture of claim 1, wherein the obtaining comprises:
fetching the key phrases from query logs;
creating one or more pairs of the key phrases; and
associating each pair of the one or more pairs with a relativity score, wherein the relativity score is based on statistical similarity between the key phrases in each pair.

4. The article of manufacture of claim 3, wherein the obtaining further comprises:
storing the one or more pairs and the relativity score associated with the each pair as the list.

5. The article of manufacture of claim 1, wherein the identifying comprises:
prioritizing the one or more key phrases.

6. The article of manufacture of claim 1, wherein the selecting comprises:
filtering the contents based on preferences of the user.

7. The article of manufacture of claim 1, wherein the providing comprises:
displaying the contents.

8. The article of manufacture of claim 1 further comprising instructions operable to cause the programmable processor to perform:
generating a list of blacklisted words.

9. An article of manufacture comprising:
a machine-readable medium for content based recommendations; and
instructions carried by the machine-readable medium and operable to cause a programmable processor to perform:
receiving a title;
generating one or more subsets of the title;
obtaining a list of key phrases;
identifying one or more key phrases from the list corresponding to the one or more subsets;
associating the title with the one or more key phrases; and
storing the title and the one or more key phrases.

10. The article of manufacture of claim 9 further comprising instructions operable to cause the programmable processor to perform:
receiving the title from a user;
retrieving the one or more key phrases;
selecting contents based on the one or more key phrases; and
providing the contents to the user.

11. An article of manufacture for content based recommendations, the article of manufacture comprising:
a machine-readable medium for content based recommendations; and
instructions carried by the machine-readable medium and operable to cause a programmable processor to perform:
identifying one or more products associated with a product relevant to a user, based on affinity based recommendation;
displaying the one or more products if the number of the one or more products meet a predefined threshold;
obtaining a list of key phrases associated with the product if the number of the one or more products does not meet a predefined threshold;
electronically identifying one or more key phrases from the list corresponding to the product;
selecting products based on the one or more key phrases; and
displaying the products to the user.

12. A method comprising:
electronically receiving, in a computer system, a title as an input;
generating one or more subsets of the title;
obtaining a list of key phrases associated with the title;
electronically identifying one or more key phrases from the list corresponding to the one or more subsets;
selecting contents based on the one or more key phrases identified; and
providing the contents to a user.

13. The method of claim 12, wherein the generating comprises:
filtering the title.

14. The method of claim 12, wherein the obtaining comprises:
fetching the key phrases from query logs;
creating one or more pairs of the key phrases; and
associating each pair of the one or more pairs with a relativity score, wherein the relativity score is based on statistical similarity between the key phrases in each pair.

15. The method of claim 14, wherein the obtaining further comprises:
storing the one or more pairs and the relativity score associated with the each pair as the list.

16. The method of claim 12, wherein the electronically identifying comprises:
prioritizing the one or more key phrases.

17. The method of claim 12, wherein the selecting comprises:
filtering the contents based on preferences of the user.

18. The method of claim 12, wherein the providing comprises:
displaying the contents.

19. The method of claim 12 further comprising:
generating a list of blacklisted words.

20. A system for content based recommendations, the system comprising:
one or more remotely located electronic devices;
a communication interface in electronic communication with the one or more remotely located electronic devices for receiving a title;
a memory for storing instructions;
a processor responsive to the instructions to generate one or more subsets of the title, to identify one or more key phrases from a list of key phrases, and to provide contents based on the one or more key phrases; and
one or more storage devices in electronic communication with the communication interface for storing the list of key phrases, the title and the one or more key phrases.
